(19) United States
(12) Patent Application Publication
(10) Pub. No.: US 2003/0233763 A1
(43) Pub. Date: Dec. 25, 2003

(54) Cleaning tool for paint appliation devices

(76) Inventor: Daniel Dean, Shell Beach, CA (US)

Correspondence Address: Daniel Dean, 106 Silver Shoals, Shell Beach, CA, 93449, US

(21) Appl. No.: 10/177,118

(22) Filed: Jun. 21, 2002

(51) Int. Cl. F26B 17/24

(52) U.S. Cl. 34/58; 34/59

(57) ABSTRACT

A cleaning tool is used to remove residual paint from paint application devices such as paintbrushes and paint rollers. The tool uses at least two pliable extensions that extend from a base. Opposite to the extensions, a chuck adaptor is provided. A paintbrush is received by, and supported between, the extensions and a paint roller can be received by and supported over the distal ends of the extensions and a portion of the base. The chuck adaptor is secured within the chuck of a drill or spinner and rotated, preferably within a container of liquid solvent such as water or paint thinner. The pliable extensions not only flex to allow the brush handle to be inserted and removed from the tool, but during the rotation of the brush within the solvent, the extensions flex slightly to allow a translating rotation of the brush through the solvent, more completely cleaning the brush and doing so in a more expeditious manner.

### FIELD OF THE INVENTION

The present invention generally relates to painting tools. More specifically, the present invention relates to paintbrush and paint roller cleaning devices.

### BACKGROUND OF THE INVENTION

Efficiency and productivity are always considerations in the development of any product used in the workplace. Painters on the jobsite are no exception to this rule. Cleaning time is unproductive time and this includes cleaning the used paintbrushes and paint rollers to remove excess paint so the brushes and rollers can be used again. After a job is completed, a paint color or paint type needs to be changed, or simply work for the day has ended, the brushes need to be cleaned to remove virtually all of the paint. When changing colors, this is obvious in that residual paint of one color will mix with the new color and alter the applied paint color. The residual color will dilute with use, altering the new color paint over a large area. When paint is left in the brush, or roller, in the air for several hours such as over night, the paint will dry, thereby making the brush or roller non-functional. Quality paintbrushes can cost in excess of $20 each. If properly cleaned these brushes can be used numerous times. If not cleaned, they must be thrown away.

The process of cleaning a paintbrush or paint roller is not trivial. A standard 4-inch brush can have 2000 bristles, each over 2 inches long. If the bristles are smooth (non-porous) this can account for over 14 square inches of surface area. If the bristles are not smooth, the resultant surface area will increase and depending upon the specifics of the bristles, the surface area can increase dramatically. The available surface area of the bristles is only part of the capability of the brush to store paint. For example, this does not take into count the droplets of paint that are held between the bristles due to friction and hydrogen bonding. In addition, the bristles will sometimes wick paint up into the base of the brush handle. This also contributes to the traditional soaking and rinsing cycle that must be repeated over and over to adequately clean a brush. The porous nature of a paint roller supplies the same difficulty in cleaning as is found with a brush, each ultimately leads to excessive unproductive time in the cleaning process.

### SUMMARY OF THE INVENTION

In one aspect, the invention features a cleaning tool with a substantially rigid base. At least two substantially longitudinal pliable extensions are also included, each with a base end secured to the base and a free end disposed opposite to the base, and each extension including a greater section modulus at the base end relative to the free end. Finally, a chuck adaptor extends from the base. This adaptor is capable of being received by the chuck of a hand drill.

The tool may also include at least one ring connector adjoining the extensions at a point between the base end and the free end. In addition the substantially longitudinal pliable extensions may include a curvilinear contour positioned adjacent to a longitudinal axis of the tool. This curvilinear contour is preferably substantially “S” shaped, thereby providing greater spacing between the extensions at a midpoint thereof relative to the base end and the free end of the extensions. The substantially longitudinal pliable extensions of the tool may also include a plurality of annular grooves positioned adjacent to the longitudinal axis.

The base of the tool may also include a tapered section capable of receiving an open end of a paint roller thereon. This tapered section can be a stepped taper, which includes a first tapered section positioned adjacent to a second tapered section. The first tapered section preferably has a small diameter of approximately 1.40 inches and a large diameter of 1.60 inches and the second tapered section has a small diameter of approximately 1.65 inches and a large diameter of 1.85 inches. The free end of the substantially longitudinal pliable extensions may also include a fin positioned away from the longitudinal axis of the tool.

In another aspect, the invention includes a method of cleaning a paint application device, including the steps of providing a cleaning tool as previously described, securing the cleaning tool in a drill, releasably securing the paint application device to the cleaning tool, engaging the drill, thereby rotating the cleaning tool and the paint application device. The forces applied due to the rotation, causing the paint to be discharged from the application device, thereby cleaning same.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is front view of a cleaning tool, showing three sections of the handle receiver, the tool produced in accordance with the present invention;

FIG. 2 is section view of a cleaning tool, along section 2-2 as shown in FIG. 1, the tool produced in accordance with the present invention;

FIG. 3 is section view of a cleaning tool, along section 3-3 as shown in FIG. 1, the tool produced in accordance with the present invention;

FIG. 4 is section view of a cleaning tool, along section 4-4 as shown in FIG. 1, the tool produced in accordance with the present invention;

FIG. 5 is front view of a cleaning tool, showing the detail of the longitudinal extensions and a stepped taper on the base, the tool produced in accordance with the present invention;

FIG. 6 is front view of a cleaning tool, showing the intended use with paint application devices shown in broken lines, the tool produced in accordance with the present invention;

FIG. 7 is front view of a cleaning tool, as it would typically be used in a drill, the tool produced in accordance with the present invention; and

FIG. 8 is front view of a cleaning tool that does not have a tapered base, the tool produced in accordance with an alternative to the present invention.

For the most part, and as will be apparent when referring to the figures, when an item is used unchanged in more than one figure, it is identified by the same alphanumeric reference indicator in all figures.

Definition of Terms

Unless otherwise defined, all technical and scientific terms used herein have the same intended meaning as would be commonly understood by anyone of ordinary skill in the art to which this invention belongs. To eliminate possible ambiguity, specific terms used have been defined as they apply to the present invention.

A “section modulus” pertains to the cross section of a beam and the distribution of the material of that cross section. The section modulus largely determines the ability of the beam to carry load without plastic deformation of the beam. It is defined as the moment of inertia, with respect to a specific central axis, in this case the long axis, divided by the distance from that axis to the extreme fiber of the section.

A “paint application device” includes all paintbrushes and paint rollers that are used to apply paint to a surface.

### DETAILED DESCRIPTION OF THE PREFERRED EMBODIMENT

The present invention is a tool used to clean paint application devices such as paintbrushes and paint rollers. The cleaning of the paintbrush or roller is primarily concerned with the removal of residual paint. Since paint application devices are designed to “apply” paint, it must enable storage of some amount of paint to transfer it from the source (paint can) to the surface being painted. As such, these devices are intentionally designed to retain paint. In order to reuse the brush or roller, it is necessary to first remove all of this residual paint.

A common tool that accompanies most commercial painters is a hand drill or spinner. A hand drill is a drill motor that is electrically or pneumatically driven to rotate a chuck, the chuck enables releasable mounting of a longitudinal item, such as a drill bit. A spinner is similar in function only it is typically hand driven by actuating a rod with a helical thread, which then rotates the chuck. Both items are intended to be hand held while the chuck is being rotated. The use of such a rotating accessory is used in conjunction with the invention to provide sufficient centrifugal forces to dislodge the paint from the brush or roller.

Referring to the drawings, FIG. 1 shows a front view of a cleaning tool 10 in its preferred embodiment. A base 12 joins a handle mount 14 to a chuck adaptor 16. The chuck adaptor 16 is a longitudinal structure that is receivable by the chuck of a drill or spinner. It is shown here to be cylindrical in shape but could just as well have a polygonal cross section as the round cross section.

The handle mount 14 is comprised of two or more substantially longitudinal extensions 18, which are pliable in nature. The pliability of these extensions 18 is necessary in that this eliminates the need for a separate locking device when a brush is received between the extensions 18 of the handle mount 14. In this, the preferred embodiment, there are four extensions 16 that are joined at intervals by ring connectors 20. The ring connectors 20 apply a radial force to a brush handle that is received within the handle mount 14. This helps hold the handle in position when the device 10 is rotating. The number of ring connectors 20 used is not considered critical to the novelty of the invention. The rigidity of the material used and the length of the extensions determine the number and position (if any) of the ring connectors 20. For example, if only two or three extensions were used, and a minimal gap between the external fibers of the extensions was maintained, the ring connectors 20 may not be deemed necessary. In a similar manner, if a more rigid material was used, the necessity of the ring connectors 20 is minimized.

The general “S” shape of the extensions 18 is done primarily to aid in the securing of the brush handle within the tool 10. This is done on several levels. Since this “S” shape is common to many paintbrush handles namely beavertail brushes. When that shape handle is received therein, the material fibers of the extensions 18 are less stressed, because they are deformed less than if the shape if the extensions 18 was not similar to the handle.

The second aspect of this shape is the “barb-like” feature of the “S” shape. This refers to the resultant frictional forces acting between the invention and the brush handle. This applies to both a beavertail brush and a round tail brush. When assembling a brush, the narrow section (near section line 2-2) acts to allow entry of the brush handle but makes it more difficult. This is partly due to the outward flair of the open free end 24, and the longitudinal structure of the extensions 18. This allows for an unobstructed entry of the brush handle, and insertion of the handle causes a compressive load on the extensions 18. This load causes the medial portion (near section 3-3) to flair out. In doing so, a smaller normal force and therefore less frictional force is applied to the handle. When pulling out the handle, the opposite happens. The extensions 18, which support the handle, are placed under tension. This tensile force pulls the medial portion in toward the handle. The displacement of the extensions 18 increases the normal force and therefore the frictional forces between the invention and the handle. The restriction to release of the handle relative to inserting the handle is valuable in that provides ease of assembly and reduced possibility of the brush becoming inadvertently dislodged while in use.

The “S” shape also allows the user to know when the brush handle is properly and securely positioned within the handle mount 14. The handle is inserted until a secure stop is felt when the brush handle end contacts the base end (near section 4-4). If the brush handle is not long enough, the handle is inserted until only the brush head is showing above the free end 24 of the invention. This also reduces the tendency for the brush to become dislodged when spinning.

The extensions 18 also include a larger cross-section and with it, a larger section modulus at the base end 22 relative to the free end 24. With a solid material, such as shown here, the increased cross-section would also result in a greater section modulus, but the important point is the increased section modulus. Therefore the base end 22 of the extension 18 could be hollow and potentially have equal or a smaller total cross-section, but the distribution of the material is such that the distance from the neutral axis to the extreme fiber is greater, to allow for greater flexural strength at the base end 22.

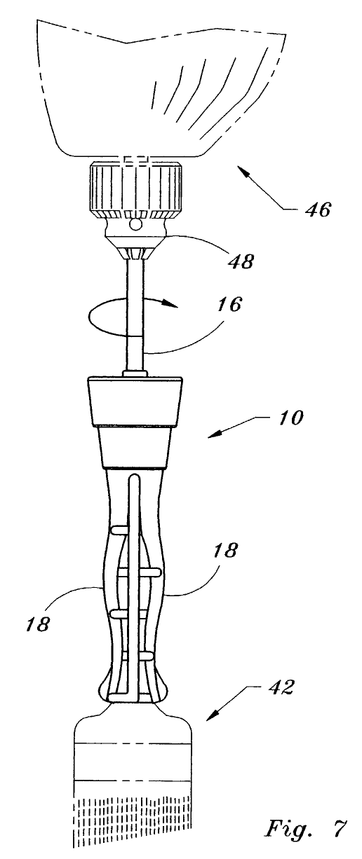

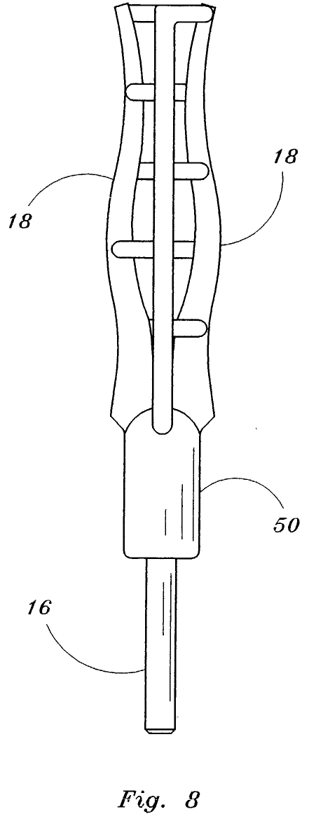

The applicant has found that some flexion of the handle mount 14 is desirable during the spinning process. If the handle mount 14 is excessively rigid, the bristles of a brush inserted into the tool 10 that are closest to the longitudinal axis 26 of the tool 10 provide very little centrifugal force, due to the minimal radius from the axis of rotation. This force is one of the critical factors in dislodging the paint. The fluid medium (air, water or another liquid solvent) in which the brush is spinning also contributes to this process. It is recommended that the user invert the tool 10, with a brush facing down (as shown in FIG. 7) and spin the tool 10 in a bucket of liquid. The viscosity of the fluid provides additional forces to dislodge the paint. If the brush or roller spins along a central and consistent axis, a vortex is created and, again, the bristles near the central axis do not get adequately cleaned. To solve this problem the inventor intentionally makes the handle mount 14 flex slightly as it spins with the brush mounted in the tool 10. This translation of the axis of rotation causes an orbital movement of the brush in the liquid. This enables more fluid contact with all bristles, which allows the brushes to be cleaned much faster.

The applicant's previous invention (U.S. Pat. No. 6,038,787) accomplished a similar Is function with the use of range limiters (item 26) on the peripheral edges of the extensions. This was functional, but the inventor later identified a safety issue associated with these range limiters, or protrusions rotating at high speed in that they could “grab” things, such as clothing or hair. The applicant has thereby accomplished a similar result without these range limiters as noted herein.

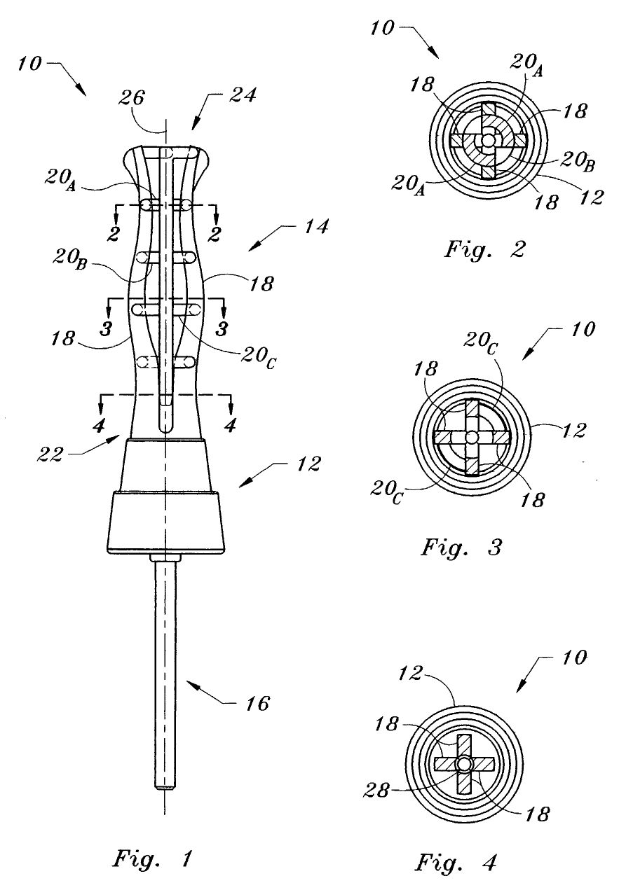

More detail of the tool 10 is shown in the sections of FIGS. 2-4. First in FIG. 2, the section is through the upper ring connectors 20_{A} and the extensions 18 near the free end 24. Here the ring connectors 20_{A} are shown to only exist in pairs, directly opposed to each other. The positioning of these pairs is alternated at each level. This is illustrated by the positioning of the next lower set of ring connectors 20_{B}. This alternating set of pairs has been found by the inventor to be preferable in allowing for flexion of the handle mount 14 to receive a brush handle and yet to support it securely when it is used. This particular arrangement is not specific to the invention nor is the use of any ring connectors 20, but has been found to be preferable.

The section of the four extensions 18 are shown as smaller in cross-section in FIG. 2 relative to FIG. 3 which is still less than that as in FIG. 4, further depicting the increasing section as the extensions near the base 12. A center hole 28 is shown in FIG. 4 may extend completely through to the base 12, or terminate above the base 12, as shown here. This hole 28 provides additional flexion of the extensions 18 to accommodate the brush handle and to enable some side-to-side flexion when the tool 10 is in use.

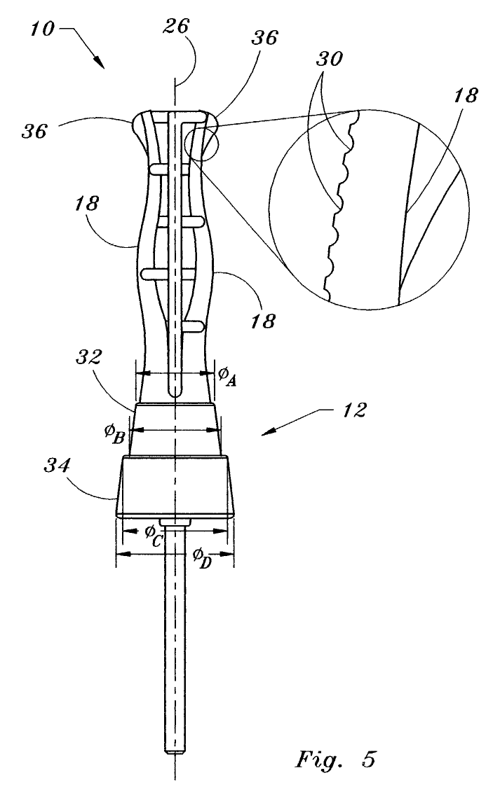

Another optimization modification has been added, and is shown in FIG. 5. The inside edges of the extensions 18, which are adjacent to the longitudinal axis 26 of the tool 10, are shown here to be fitted with a series of annular grooves 30. These grooves 30 are desirable in that these portions of the extensions 18 directly contact the brush handle. The handle is commonly wet from paint or some cleaning fluid that may have been used. As previously mentioned, the brush is commonly cleaned in a liquid solvent such as water or paint thinner, therefore the brush handle is commonly wet. Since moisture will act as a lubricant and reduce the coefficient of static friction between the handle and the extension 18, it is desirable to channel the moisture away from the contact surface. Just as a tread on a tire allows water on the road to flow away from the contact area of the road and the tire rubber, these annular grooves 30 allow the liquid on the brush handle to be displaced away from the brush handle and the contact area of the extension 18. In doing so, the annular grooves 30 reduce the likelihood of the brush slipping free when the tool 10 is in use.

The base 12 is shown here with a stepped taper. This comprises a first tapered section 32 positioned adjacent to a second tapered section 34. These tapered sections are intended to receive the open end of a paint roller. The taper allows the interior diameter of the roller to be wedged onto the base 12, thus supporting it regardless of minor wear or deformity of the used rollers or the tool 10, over time. The stepped taper allows a minimal slope of the conical sections, while allowing for both U.S. and European sized rollers. Rollers in the U.S. have an inside diameter of approximately 1.5 inches. European rollers have an inside diameter of around 1.75 inches (approximately 45 mm). Therefore, the U.S. rollers would be received by the first taper 32 and the European rollers would be received by the second taper 34.

Since these sizes vary by roughly 0.25 inches, it is possible to make one taper that would enable support of both sizes, but as previously stated, it is preferable to keep the angle of incline as small as possible, so as to maximize the area of contact when the roller and base 12 are slightly deformed as the roller is pressed on by hand. This acts to better secure the roller on the tool 10. Just as the necessity of one continuous step or two adjacent steps is not critical to the scope of the invention, the actual diameters can also vary somewhat. The inventor has determined the optimal ranges for the first taper are from a small diameter (Φ_{A}) of 1.40 inches and a large diameter (Φ_{B}) of 1.60 inches. The second tapered section preferably has a small diameter (Φ_{c}) of 1.65 inches and a large diameter (Φ_{D}) of 1.85 inches.

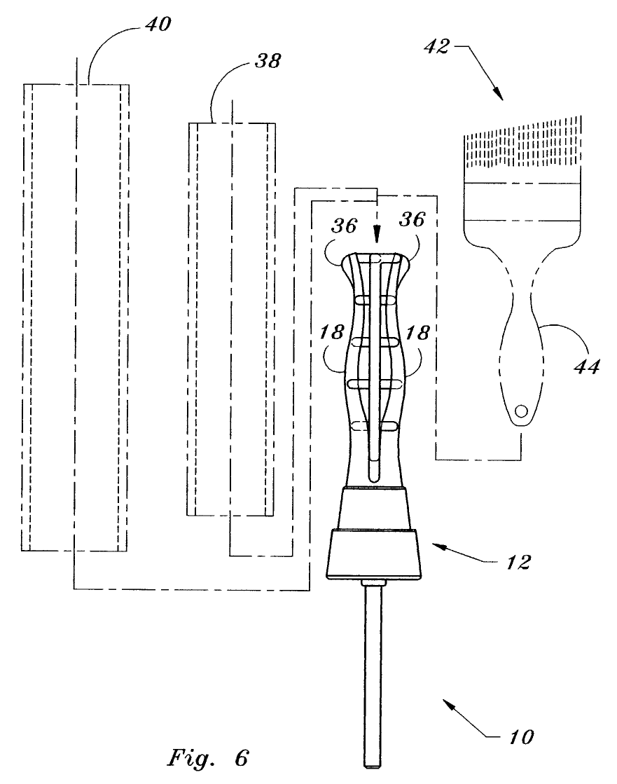

To further assist in holding the roller on the tool 10 while in use, a pair of fins 36 are positioned near the free end of the extensions 18. This is further illustrated in FIG. 6. Here a U.S. sized roller 38 and a European sized roller 40 are depicted as they would be received by, and supported on, the exterior of the fins 36 and the base 12 of the tool 10. In a similar manner, a brush 42 is shown as it would be received by, and supported within, the extensions 18 of the tool 10. Here it is also shown that the typical brush handle 44 follows the general contour of the interior profile of the extensions 18 when in their natural state.

A system in use is illustrated in FIG. 7. A drill 46 with a chuck 48 receives the chuck adaptor 16 of the tool 10. The chuck 48 grips the chuck adaptor 16 so that as the drill 46 rotates the chuck 48, the tool 10 also rotates. The brush 42 is received within the extensions 18 of the tool 10. In most cases it is advantageous for the brush handle to be fully received by the tool 10, as shown here. The more of the handle that makes contact with the tool 10, the more secure the brush 42 will be when it is being rotated by the drill 46. Since high rotational speeds can be produced by the drill and therefore relatively high forces due to the resistance of the translating and rotating brush in the fluid cleaning medium, a great deal of “cleaning force” is applied to the brush head. Obviously this only works if the brush 42 does not move within the tool 10, and even more obviously if the brush 42 does not fall out of the tool 10 when in use. Another important factor is safety in assuring that the brush 42 stays within the tool 10 when in use, but still providing the ability to quickly and effectively remove the brush 42 when finished cleaning and insert a new brush 42 in the tool to use it again. The inventor has determined these factors to be met with the invention as disclosed by using a rubber material. This can be a synthetic or natural rubber. The natural rubber or any material formed from naturally occurring latex can be used. The modern synthetic rubbers such as styrene-butadiene rubber (SBR), neoprene and polyurethane rubbers are in many cases preferable due to their high mechanical strength and greater resistance to wear. Material properties are also important here regarding the potential for chemical interaction with different solvents. This makes synthetic rubbers preferable.

Another version of the invention is shown in FIG. 8. The extensions 18 have the same basic shape and function as previously disclosed. The base has been changed to not enable supporting a roller. This narrow base 50 is used to simply support the extensions 18 and the chuck adaptor 16. When rollers are not used, this version of the invention offers a slightly lower cost and lighter weight tool for the painter that wishes to clean paintbrushes.

It is to be understood that all of the enclosed information is presented as the preferred embodiment, or alternatives thereof, as seen by the inventor. An infinite number of variations and modifications can be made including the use and positioning of the ring connectors and details including the number of extensions are possible and therefore inherently included in the scope of this disclosure.

What is claimed is:

1. A cleaning tool comprising:
a substantially rigid base;
at least two substantially longitudinal pliable extensions, each with a base end secured to said base and a free end disposed opposite to said base, and each extension including a greater section modulus at said base end relative to said free end; and
a chuck adaptor extending from said base, the adaptor capable of being received by the chuck of a hand drill.

2. The tool as in claim 1, further comprising at least one ring connector adjoining said extensions at a point between said base end and said free end.

3. The tool as in claim 1, wherein said substantially longitudinal pliable extensions include a curvilinear contour adjacent to a longitudinal axis of said tool.

4. The tool as in claim 3, wherein said curvilinear contour is substantially “S” shaped providing greater spacing between said extensions at a midpoint thereof relative to said base end and said free end.

5. The tool as in claim 1, wherein said substantially longitudinal pliable extensions include a plurality of annular grooves positioned adjacent to a longitudinal axis of said tool.

6. The tool as in claim 1, wherein said base includes a tapered section capable of receiving an open end of a paint roller thereon.

7. The tool as in claim 6, wherein said tapered section is a stepped taper, which includes a first tapered section positioned adjacent to a second tapered section.

8. The tool as in claim 7, wherein said first tapered section has a small diameter of 1.40 inches and a large diameter of 1.60 inches and said second tapered section has a small diameter of 1.65 inches and a large diameter of 1.85 inches.

9. The tool as in claim 1, wherein said free end of said substantially longitudinal pliable extensions includes a fin positioned away from a longitudinal axis of said tool.

10. A rotary cleaning tool comprising:
a handle receiver with a curvilinear edge, further including a base end and a free end, and adapted to receive a handle of a paint brush;
a base supporting said handle receiver and positioned adjacent to said base end of said handle receiver; and
a chuck adaptor extending from said base, the adaptor capable of being received by the chuck of a drill.

11. The tool as in claim 10, wherein said base end of said handle receiver has a larger cross-section relative to said free end.

12. The tool as in claim 10, wherein said handle receiver is comprised of more than one extension member, the tool further comprising at least one ring connector adjoining said more than one extension member at a point between said base end and said free end.

13. The tool as in claim 10, wherein said curvilinear edge is adjacent to a longitudinal axis of said tool.

14. The tool as in claim 13, wherein said curvilinear edge is substantially “S” shaped providing a greater opening within said handle receiver at a midpoint thereof relative to said base end and said free end.

15. The tool as in claim 10, wherein said substantially longitudinal pliable extensions include a plurality of annular grooves positioned adjacent to a longitudinal axis of said tool.

16. The tool as in claim 10, wherein said base includes a tapered section capable of receiving an open end of a paint roller thereon.

17. The tool as in claim 16, wherein said tapered section is a stepped taper, which includes a first tapered section positioned adjacent to a second tapered section.

18. The tool as in claim 17, wherein said first tapered section has a small diameter of 1.40 inches and a large diameter of 1.60 inches and said second tapered section has a small diameter of 1.65 inches and a large diameter of 1.85 inches.

19. The tool as in claim 10, wherein said free end of said substantially longitudinal pliable extensions includes a fin positioned away from a longitudinal axis of said tool.

20. A method of cleaning a paint application device, including the steps of:
providing a cleaning tool comprising:
a substantially rigid base;
at least two substantially longitudinal pliable extensions, each with a base end secured to said base and a free end disposed opposite to said base, and each extension including a greater section modulus at said base end relative to said free end; and
a chuck adaptor extending from said base, the adaptor capable of being received by the chuck of a hand drill;
securing said cleaning tool in a drill;
releasably securing said paint application device to said cleaning tool;
engaging said drill, rotating said cleaning tool and said paint application device, the forces due to the rotation discharging paint from said application device, thereby cleaning same.
